(19) United States
(12) Patent Application Publication
(10) Pub. No.: US 2026/0166851 A1
(43) Pub. Date: Jun. 18, 2026

(54) METAL MATRIX COMPOSITE STRUCTURE WITH ULTRASONIC BONDING

(71) Applicant: Touchstone Research Laboratory, Ltd., Triadelphia, WV (US)

(72) Inventors: Brandon J. Coates, Shadyside, OH (US); Brian L. Gordon, Wheeling, WV (US); Brian E. Joseph, Triadelphia, WV (US)

(21) Appl. No.: 18/979,757

(22) Filed: Dec. 13, 2024

(51) Int. Cl. B32B 15/01; B32B 7/03; B32B 37/10

(52) U.S. Cl. CPC B32B 15/016; B32B 7/03; B32B 37/1045; B32B 2250/05; B32B 2260/021; B32B 2307/7376

(57) ABSTRACT

The present disclosure provides a composite structure comprising an upper face sheet and a lower face sheet, each comprising a plurality of metal matrix composite (MMC) layers, and a metallic core positioned between the upper face sheet and the lower face sheet. The MMC layers of the upper face sheet and the lower face sheet are oriented at angles relative to one another. The MMC layers of the upper face sheet and the lower face are joined to the metallic core through an ultrasonic bond. The composite structure offers a combination of high strength, light weight, and customizable properties for various applications in aerospace, automotive, and other industries requiring advanced materials.

### TECHNICAL FIELD

The present disclosure relates to composite structures, and more particularly to a lightweight composite sandwich structure comprising metal matrix composite tape face sheets ultrasonically welded to a metallic core.

### BACKGROUND

Composite structures combining high strength and low weight are increasingly important in various industries, including aerospace, automotive, and construction. These structures often utilize sandwich configurations, where two face sheets are bonded to a lightweight core material. Traditional composite sandwich structures typically employ polymer-based face sheets and cores, which may have limitations in high-temperature or electrically conductive applications.

Metal matrix composites (MMCs) have emerged as promising materials for advanced applications due to their unique combination of metallic and ceramic properties. However, incorporating MMCs into sandwich structures presents challenges in terms of manufacturing complexity, weight optimization, and bonding techniques. There is a growing need for composite structures that can leverage the benefits of MMCs while maintaining the advantages of sandwich configurations, particularly for applications requiring high strength-to-weight ratios, thermal stability, and electrical conductivity.

There is a need for a lightweight composite sandwich structure that combines the strength and versatility of metal matrix composites with the structural benefits of a sandwich configuration, while overcoming manufacturing and bonding challenges.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a composite structure is provided. The composite structure includes an upper face sheet comprising a plurality of metal matrix composite (MMC) layers, a lower face sheet comprising a plurality of metal matrix composite (MMC) layers, and a metallic core positioned between the upper face sheet and the lower face sheet. The MMC layers of the upper face sheet and the lower face sheet are oriented at angles relative to one another. The MMC layers of the upper face sheet and the lower face are joined to the metallic core through an ultrasonic bond.

According to other aspects of the present disclosure, the composite structure may include one or more of the following features. The angles at which the MMC layers are oriented relative to one another may be between about 5 and about 90 degrees. Each MMC layer may comprise MMC tape having a width between about 0.5 inches and about 2 inches. Each MMC layer may comprise MMC tape having a thickness between about 0.01 inches and about 0.03 inches. The MMC layers may comprise continuous fibers selected from the group consisting of carbon fibers, silicon carbide fibers, boron fibers, and aluminum oxide fibers. The MMC layers may comprise discontinuous fibers selected from the group consisting of whiskers, chopped fibers, and particulates. The MMC layers may comprise a metal matrix selected from the group consisting of aluminum, titanium, magnesium, and alloys thereof. Each of the upper face sheet and the lower face sheet may comprise between 2 and about 10 MMC layers joined together by an ultrasonic bond. The metallic core may comprise a metal selected from the group consisting of aluminum, magnesium, titanium, steel, and alloys thereof. The metallic core may have a form selected from the group consisting of a honeycomb structure, a hollow extrusion, a corrugated structure, a truss structure, and a foam structure.

According to another aspect of the present disclosure, a composite structure is provided. The composite structure includes an upper face sheet comprising a plurality of metal matrix composite (MMC) layers, wherein the MMC layers comprise an aluminum matrix, a lower face sheet comprising a plurality of metal matrix composite (MMC) layers, wherein the MMC layers comprise an aluminum matrix, and an aluminum core positioned between the upper face sheet and the lower face sheet. The MMC layers of the upper face sheet and the lower face sheet are oriented at angles relative to one another. In some aspects, the MMC layers of the upper face sheet are oriented at angles ranging from about 0 degrees to about 90 degrees relative to one another and the MMC layers of the lower face sheet are oriented at angles ranging from about 0 degrees to about 90 degrees relative to one another. The MMC layers of the upper face sheet and the lower face are joined to the metallic core through an ultrasonic bond.

According to other aspects of the present disclosure, the composite structure may include one or more of the following features. The upper face sheet may comprise between 2 and about 10 MMC layers, and the lower face sheet may comprise between 2 and about 10 MMC layers joined together by an ultrasonic bond. Each MMC layer may comprise MMC tape having a width between about 0.5 inches and about 2 inches. Each MMC layer may comprise MMC tape having a thickness between about 0.01 inches and about 0.03 inches. The aluminum core may have a form selected from the group consisting of a honeycomb structure, a hollow extrusion, a corrugated structure, a truss structure, and a foam structure.

According to another aspect of the present disclosure, a method for making a composite structure is provided. The method includes providing a plurality of metal matrix composite (MMC) layers for an upper face sheet, providing a plurality of metal matrix composite (MMC) layers for a lower face sheet, orienting the MMC layers of the upper face sheet and the lower face sheet at angles relative to one another, providing a metallic core, positioning the metallic core between the upper face sheet and the lower face sheet, and ultrasonically bonding the upper face sheet, the lower face sheet, and the metallic core together to form the composite structure.

According to other aspects of the present disclosure, the method may include one or more of the following features. The MMC layers of the upper face sheet and the lower face sheet may comprise a metal matrix selected from the group consisting of aluminum, titanium, magnesium, and alloys thereof. Orienting the MMC layers of the upper face sheet and the lower face sheet at angles relative to one another may comprise orienting the layers at angles between about 5 and about 90 degrees. Each MMC layer may comprise MMC tape having a width between about 0.5 inches and about 2 inches and a thickness between about 0.01 inches and about 0.03 inches. The metallic core may have a form selected from the group consisting of a honeycomb structure, a hollow extrusion, a corrugated structure, a truss structure, and a foam structure. Providing the plurality of MMC layers for the upper face sheet and providing the plurality of MMC layers for the lower face sheet may comprise providing between 2 and about 10 MMC layers for each of the upper face sheet and the lower face sheet. The method may further comprise ultrasonically welding the MMC layers of the upper face sheet together and ultrasonically welding the MMC layers of the lower face sheet together prior to positioning the metallic core between the upper face sheet and the lower face sheet.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates an isometric view of a composite structure, according to aspects of the present disclosure.

FIG. 2 illustrates a side view of the composite structure of FIG. 1, according to an embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present invention provides a composite structure that combines the strength and versatility of metal matrix composite (MMC) tape with the structural benefits of a sandwich configuration. This composite structure includes an upper face sheet and a lower face sheet, each comprising a plurality of MMC layers, and a metallic core positioned between the upper and lower face sheets. The MMC layers of the upper and lower face sheets are oriented at angles relative to one another, providing flexibility in tailoring the mechanical properties of the structure. A key feature of this composite structure is the use of ultrasonic bonding to join the MMC layers of the upper and lower face sheets to the metallic core. This bonding technique offers several advantages over traditional adhesive bonding or mechanical fastening methods, including rapid bonding, no need for additional materials, a clean process, precise control, and low heat input. The composite structure may find utility in various applications requiring high strength-to-weight ratios, thermal stability, and electrical conductivity.

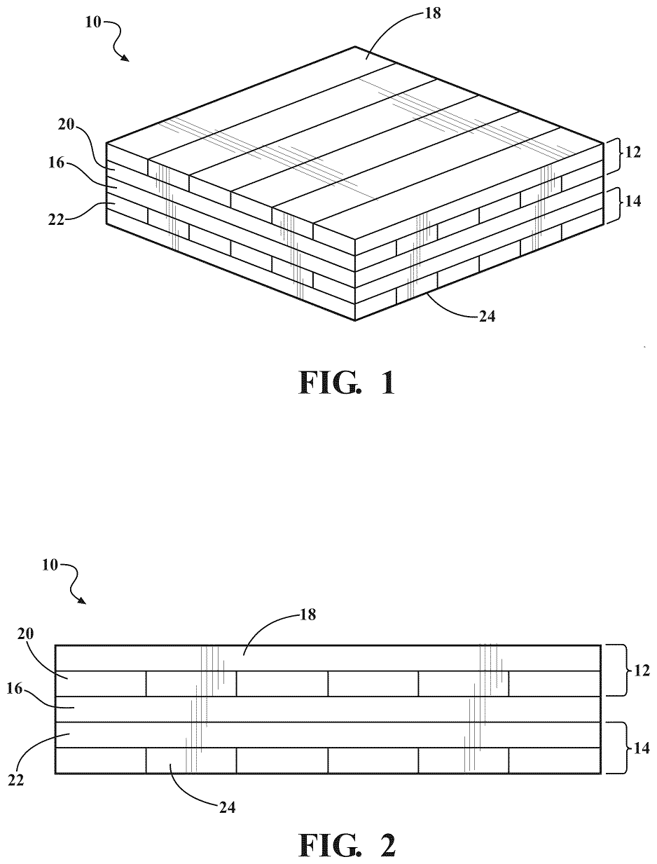

Referring to FIG. 1, the composite structure 10 is shown in an isometric view. The composite structure 10 includes an upper face sheet 12, a lower face sheet 14, and a metallic core 16 sandwiched between the upper and lower face sheets.

In some aspects, the upper face sheet 12 comprises a plurality of metal matrix composite (MMC) layers. These layers may include a first MMC layer of upper face sheet 18 and a second MMC layer of upper face sheet 20. The MMC layers of the upper face sheet 12 may comprise an aluminum matrix, although other metal matrices may be used in other embodiments. The number of MMC layers in the upper face sheet 12 can vary based on the specific requirements of the application. Typically, the number of layers ranges from about 2 to about 10, but it can exceed 10 for applications demanding higher strength or stiffness.

The metallic core 16 is positioned between the upper face sheet 12 and the lower face sheet 14. The metallic core 16 may be composed of various metals or their alloys, primarily aluminum, magnesium, titanium, or alloys of these. In some cases, the metallic core 16 may have a solid structure, as depicted in FIG. 1. However, in other embodiments, the metallic core 16 may have its own structure such as a honeycomb, hollow extrusion, or foam. This would reduce the overall weight while maintaining the stiffness of the design.

The MMC layers of the upper face sheet 12 are ultrasonically bonded to the metallic core 16. This joining method contributes to the overall structural integrity and performance of the composite structure 10. The ultrasonic welding process ensures a strong, reliable bond between the face sheets and the core without the need for adhesives, mechanical fasteners, or brazing materials.

In some embodiments, the metallic core 16 and the metal matrix of the MMC layers in the upper face sheet 12 may be composed of the same metal. This can ensure compatibility in terms of thermal expansion, welding characteristics, and overall structural integrity. However, in other embodiments, the metallic core 16 and the metal matrix of the MMC layers in the upper face sheet 12 may be composed of different metals, as long as the metal matrix of the MMC layers can be ultrasonically welded to the metallic core 16.

Referring to FIG. 1, the lower face sheet 14 of the composite structure 10 also comprises a plurality of metal matrix composite (MMC) layers. These layers may include a first MMC layer of lower face sheet 22 and a second MMC layer of lower face sheet 24. Similar to the upper face sheet 12, the MMC layers of the lower face sheet 14 may comprise an aluminum matrix in some embodiments, although other metal matrices may be used in other embodiments. The number of MMC layers in the lower face sheet 14 can also vary based on the specific requirements of the application. Typically, the number of layers ranges from about 2 to about 10, but it can exceed 10 for applications demanding higher strength or stiffness.

The MMC layers of the lower face sheet 14 are ultrasonically bonded to the metallic core 16. This joining method contributes to the overall structural integrity and performance of the composite structure 10. The ultrasonic welding process ensures a strong, reliable bond between the face sheets and the core without the need for adhesives, mechanical fasteners, or brazing materials.

In some embodiments, the metallic core 16 and the metal matrix of the MMC layers in the lower face sheet 14 may be composed of the same metal. This can ensure compatibility in terms of thermal expansion, welding characteristics, and overall structural integrity. However, in other embodiments, the metallic core 16 and the metal matrix of the MMC layers in the lower face sheet 14 may be composed of different metals, as long as the metal matrix of the MMC layers can be ultrasonically welded to the metallic core 16.

The orientation of the MMC layers in both the upper face sheet 12 and the lower face sheet 14 is an important feature of the composite structure 10. In some aspects, the MMC layers of the upper face sheet 12 and the lower face sheet 14 are oriented at angles relative to one another. This angular arrangement allows for the tailoring of mechanical properties in different directions, enhancing the overall performance of the composite structure 10. In some aspects, the MMC layers of the upper face sheet are oriented at angles ranging from about 0 degrees to about 90 degrees relative to one another and the MMC layers of the lower face sheet are oriented at angles ranging from about 0 degrees to about 90 degrees relative to one another, The angles at which the MMC layers are oriented relative to one another may be between about 5 degrees and about 90 degrees in some embodiments. This flexibility in the orientation of the MMC layers allows for customization of the composite structure 10 to meet specific geometric or performance requirements.

Referring to FIG. 2, a side view of the composite structure 10 is illustrated. The composite structure 10 includes an upper face sheet 12, a lower face sheet 14, and a metallic core 16 positioned between the upper and lower face sheets.

In some aspects, the upper face sheet 12 comprises a plurality of metal matrix composite (MMC) layers. These layers may include a first MMC layer of upper face sheet 18 and a second MMC layer of upper face sheet 20. The MMC layers of the upper face sheet 12 are oriented at angles relative to one another. These angles may range from about 5 degrees to about 90 degrees in some embodiments. This angular arrangement allows for the tailoring of mechanical properties in different directions, enhancing the overall performance of the composite structure 10.

Similarly, the lower face sheet 14 comprises a plurality of MMC layers, including a first MMC layer of lower face sheet 22 and a second MMC layer of lower face sheet 24. These layers are also oriented at angles relative to one another, which may range from about 5 degrees to about 90 degrees in some embodiments.

In some cases, the upper face sheet 12 and the lower face sheet 14 each comprise between 2 and about 10 MMC layers or more depending on the application. These layers are joined together by an ultrasonic bond, contributing to the overall structural integrity and performance of the composite structure 10.

The metallic core 16 is positioned between the upper face sheet 12 and the lower face sheet 14. In some embodiments, the metallic core 16 may be composed of aluminum, although other metals or alloys may be used in other embodiments. The metallic core 16 provides structural support to the composite structure 10 and increases the overall stiffness and bending resistance of the structure.

In some aspects, the upper face sheet 12 and the lower face sheet 14 may be balanced to optimize the overall performance and stability of the composite structure 10. Balancing the face sheets may involve considering factors such as the number of MMC layers, their orientation, thickness, and composition.

The number of MMC layers in the upper face sheet 12 and the lower face sheet 14 may be equal or similar to maintain symmetry in the composite structure 10. For example, if the upper face sheet 12 comprises four MMC layers, the lower face sheet 14 may also comprise four MMC layers. This symmetrical configuration may help prevent warping or distortion of the composite structure 10 under various loading conditions.

The orientation of the MMC layers in the upper face sheet 12 and the lower face sheet 14 may be mirrored or complementary to each other. For instance, if the first MMC layer of the upper face sheet 18 is oriented at a 45-degree angle relative to the longitudinal axis of the composite structure 10, the first MMC layer of the lower face sheet 22 may be oriented at a −45-degree angle. This balanced orientation may help distribute stresses evenly throughout the structure and provide consistent mechanical properties in different directions.

In some cases, the thickness of the MMC layers in the upper face sheet 12 and the lower face sheet 14 may be matched to ensure uniform load distribution. The total thickness of the upper face sheet 12 may be approximately equal to the total thickness of the lower face sheet 14, contributing to the overall balance of the composite structure 10.

The composition of the MMC layers in the upper face sheet 12 and the lower face sheet 14 may be selected to achieve balance in terms of thermal expansion, stiffness, and strength. Using the same metal matrix and fiber reinforcement in both face sheets may help ensure consistent behavior under various environmental conditions.

In some embodiments, the balancing of the upper face sheet 12 and the lower face sheet 14 may be tailored to meet specific performance requirements. For example, in applications where bending loads are not symmetrical, the face sheets may be intentionally unbalanced to optimize the structure's response to the expected loading conditions.

The balancing of the face sheets may also consider the properties of the metallic core 16. The thickness and properties of the upper face sheet 12 and the lower face sheet 14 may be selected to complement the characteristics of the metallic core 16, creating a well-balanced composite structure 10 that maximizes the benefits of the sandwich configuration.

In some aspects, the upper face sheet 12 and the lower face sheet 14 do not necessarily need to be exactly parallel or directly opposite each other. This design flexibility allows for customization of the composite structure 10 to meet specific geometric or performance requirements. For instance, the upper face sheet 12 and the lower face sheet 14 may be oriented in such a way that they are not exactly balanced. This could be advantageous in certain applications where some variation in the properties of the top and bottom of the composite structure 10 is desirable. However, it should be noted that any variation between the upper face sheet 12 and the lower face sheet 14 should be carefully engineered to ensure that the overall structural integrity, dimensional stability, and performance requirements of the composite structure 10 are met.

Referring to FIG. 2, the composite structure 10 is shown in a side view, providing a detailed perspective of the MMC layers in the upper face sheet 12 and the lower face sheet 14. In some aspects, each MMC layer in the upper face sheet 12 and the lower face sheet 14 comprises MMC tape. The width of the MMC tape in each layer may range from about 0.5 inches to about 2 inches in some embodiments. This range of widths allows for flexibility in the design of the composite structure 10, accommodating different application requirements and manufacturing processes.

In addition to the width, the thickness of the MMC tape in each layer can also be tailored to meet specific performance criteria. In some cases, the thickness of the MMC tape may range from about 0.01 inches to about 0.03 inches. This range of thicknesses provides a balance between strength and weight, enabling the design of lightweight yet robust composite structures.

The MMC layers of the upper face sheet 12 and the lower face sheet 14 are joined to the metallic core 16 through an ultrasonic bond. This bonding technique contributes to the overall structural integrity and performance of the composite structure 10. The ultrasonic welding process ensures a strong, reliable bond between the face sheets and the core without the need for adhesives, brazing materials, or mechanical fasteners. This method of joining also allows for precise control of the bonding process, maintaining the carefully designed orientation of each layer while minimizing potential distortions or misalignments.

Most metals have surface oxide layers as well as asperities on their surfaces, such as unevenness of the surface, roughness, or ruggedness that keep metals from bonding together. Without intending to be bound by theory, it is believed the ultrasonic welding process assists in the breaking up and/or removal of the oxide layer such that intimate contact occurs between portions of the metal surfaces allowing for the metal substrates to join together in a solid-state weld. In this process, localized temperatures around the metal joint or weld may be about 30% to 50% of the typical melting temperature of the metal. In some embodiments, the ultrasonic welding process involves applying pressure to the materials to be joined while simultaneously introducing high-frequency vibrations, typically in the range of 20-40 kHz. These vibrations cause the materials to vibrate against each other, generating friction and heat at the interface. The combination of heat and pressure facilitates the breaking up or removal of surface oxide layers and reduction of surface asperities allowing for a solid-state, metallurgical bond or weld between the surfaces when cooled.

In the composite structure 10, each individual layer of MMC tape in the upper face sheet 12 and the lower face sheet 14 is ultrasonically welded to adjacent layers, creating a cohesive, multi-layered structure. This process ensures strong interlayer bonding, enhancing the overall strength and integrity of the face sheets. Furthermore, each completed face sheet layer of MMC tape is ultrasonically welded to the surface of the metallic core 16. This direct bonding method creates a robust interface between the face sheets and the core, eliminating the need for adhesives, brazing materials, or mechanical fasteners.

The use of ultrasonic welding for both interlayer and face sheet-to-core bonding ensures consistency in the joining process throughout the structure. This uniformity contributes to the overall reliability and performance of the composite structure 10, reducing the risk of delamination or interface failure under various loading conditions. Additionally, the absence of adhesives or mechanical fasteners simplifies the manufacturing process, potentially reducing production time and costs while maintaining high structural integrity.

In some aspects, the MMC layers of the upper face sheet 12 and the lower face sheet 14 comprise MMC tapes having continuous fibers embedded in a metal matrix. These fibers may be selected from a group consisting of carbon fibers, silicon carbide fibers, boron fibers, and aluminum oxide fibers. The selection of fibers depends on the desired characteristics and the compatibility with the metal matrix. For instance, carbon fibers, known for their high strength-to-weight ratio and excellent stiffness, are widely used in aerospace and high-performance applications. Boron fibers offer exceptional stiffness and compressive strength, making them suitable for applications requiring high dimensional stability. Silicon carbide fibers, characterized by high temperature resistance and good thermal conductivity, are often used in high-temperature applications. Aluminum oxide (Alumina) fibers provide excellent strength and stiffness, particularly at high temperatures, and are chemically compatible with aluminum matrices.

In other cases, the MMC layers of the upper face sheet 12 and the lower face sheet 14 may comprise discontinuous fibers. These fibers may be selected from a group consisting of whiskers, chopped fibers, and particulates. The use of discontinuous fibers can offer certain advantages, such as improved isotropic properties and ease of processing, while still enhancing the overall strength and stiffness of the MMC layers.

The MMC layers of the upper face sheet 12 and the lower face sheet 14 also comprise MMC tape having a metal matrix. The choice of matrix metal is important in determining the overall properties of the MMC tape. In some embodiments, the metal matrix may be selected from a group consisting of aluminum, titanium, magnesium, and alloys thereof. For example, aluminum is a desired matrix metal due to its low density, good corrosion resistance, and excellent thermal and electrical conductivity. Magnesium offers even lower density than aluminum, making it suitable for ultra-lightweight applications. Titanium provides superior strength and corrosion resistance, ideal for high-performance applications.

The metallic core 16, positioned between the upper face sheet 12 and the lower face sheet 14, may comprise a metal selected from a group consisting of aluminum, magnesium, titanium, and alloys thereof. Other materials for the metallic core 16 may include but are not limited to steel or nickel alloys. The choice of core material depends on the specific requirements of the application, including weight constraints, strength needs, thermal management, and cost considerations. For instance, aluminum is known for its lightweight properties and good strength-to-weight ratio, making it a popular choice for aerospace and automotive applications. Magnesium, even lighter than aluminum, offers excellent strength and stiffness, making it suitable for ultra-lightweight designs. Titanium, while heavier than aluminum and magnesium, provides superior strength and corrosion resistance, ideal for high-performance applications.

In some embodiments, the MMC tape used in the MMC layers of the upper face sheet 12 and the lower face sheet 14 may include fibers such as carbon fibers, boron fibers, silicon carbide fibers, aluminum oxide fibers, glass fibers, quartz fibers, basalt fibers, ceramic fibers, or metal fibers. The selection of these fibers can be tailored to meet the specific performance requirements of the composite structure 10, offering a wide range of mechanical properties and functional characteristics.

In some aspects, the metallic core 16 may have a form selected from a group consisting of a honeycomb structure, a hollow extrusion, a corrugated structure, a truss structure, and a foam structure. These different forms can provide various benefits, such as weight reduction, increased stiffness, improved thermal management, and enhanced energy absorption. For instance, a honeycomb structure can offer excellent strength-to-weight ratios and is widely used in aerospace applications. A hollow extrusion, on the other hand, can provide a balance between weight reduction and structural integrity, making it suitable for automotive and construction applications. A foam structure, created by introducing gas bubbles into molten metal, can offer ultra-low density while maintaining reasonable strength, making it ideal for energy absorption and thermal insulation applications.

In some cases, each MMC layer in the upper face sheet 12 and the lower face sheet 14 comprises MMC tape. The thickness of the MMC tape in each layer can be tailored to meet specific performance criteria. For instance, the thickness of the MMC tape may range from about 0.01 inches to about 0.03 inches. A preferred thickness may be approximately 0.015 inches. This range of thicknesses provides a balance between strength and weight, enabling the design of lightweight yet robust composite structures.

The cross-sectional shape of the MMC tape is not particularly limited but preferably includes relatively flat sides that may be abutted against flat sides of adjacent pieces of MMC tape. Suitable cross-sectional shapes may include regular or irregular polygons, including but not limited to, a regular triangle, an acute triangle, a right triangle, an obtuse triangle, a parallelogram, a square, a rectangle, a trapezium, a kite, a rhombus, a pentagon, a hexagon, a heptagon, an octagon, a nonagon, a decagon, or other quadrilateral. In certain embodiments, the MMC has a rectangular cross section. The choice of cross-sectional shape can influence ease of layup and manufacturing, interlocking capabilities between adjacent tapes, specific strength characteristics in different directions, and the ability to conform to complex geometries.

The MMC layers of the upper face sheet 12 and the lower face sheet 14 are joined to the metallic core 16 through an ultrasonic bond. This bonding technique contributes to the overall structural integrity and performance of the composite structure 10. The ultrasonic welding process ensures a strong, reliable bond between the face sheets and the core without the need for adhesives, brazing materials, or mechanical fasteners. This method of joining also allows for precise control of the bonding process, maintaining the carefully designed orientation of each layer while minimizing potential distortions or misalignments.

In some embodiments, the ultrasonic welding process involves applying pressure to the materials to be joined while simultaneously introducing high-frequency vibrations, typically in the range of 20-40 kHz. These vibrations cause the materials to vibrate against each other, generating friction and heat at the interface. The combination of heat and pressure facilitates the breaking up or removal of surface oxide layers and reduction of surface asperities allowing for a solid-state, metallurgical bond or weld between the surfaces when cooled.

In the composite structure 10, each individual layer of MMC tape in the upper face sheet 12 and the lower face sheet 14 is ultrasonically welded to adjacent layers, creating a cohesive, multi-layered structure. This process ensures strong interlayer bonding, enhancing the overall strength and integrity of the face sheets. Furthermore, each completed face sheet layer of MMC tape is ultrasonically welded to the surface of the metallic core 16. This direct bonding method creates a robust interface between the face sheets and the core, eliminating the need for adhesives, brazing materials, or mechanical fasteners.

In some aspects, the metal matrix of the MMC layers in the upper face sheet 12 and the lower face sheet 14 may include metals other than aluminum and magnesium. For instance, the metal matrix may comprise silver, gold, platinum, copper, palladium, zinc, or alloys thereof. The selection of these metals can be tailored to meet the specific performance requirements of the composite structure 10, offering a wide range of mechanical properties and functional characteristics. For example, silver and copper provide excellent electrical and thermal conductivity, making them suitable for applications requiring efficient heat dissipation or electrical conductivity. Gold and platinum offer superior corrosion resistance and high-temperature properties, making them ideal for extreme environments or high-performance applications. Palladium and zinc, on the other hand, can provide unique properties such as catalytic activity or galvanic protection, respectively.

In some aspects, the dimensions of the upper face sheet 12 and the lower face sheet 14 may not be limited to specific sizes. The composite structure 10 may be scaled to various dimensions by adjusting the number and arrangement of MMC tape layers in the face sheets. For larger face sheets, additional MMC tape may be incorporated to achieve the desired size and performance characteristics. This scalability allows the composite structure 10 to be adapted for a wide range of applications, from small components to large structural elements.

The flexibility in sizing may be achieved by adding more MMC tape layers, increasing the width or length of individual MMC tape pieces, or a combination of both approaches. In some cases, the number of MMC layers in the face sheets may be increased to maintain the desired thickness-to-width ratio for larger structures. The orientation angles between layers may also be adjusted to optimize the mechanical properties for different scale applications.

The metallic core 16 may similarly be scaled to match the dimensions of the enlarged face sheets. Depending on the specific core structure (e.g., honeycomb, foam, or truss), the scaling process may involve expanding the core pattern or increasing the number of core elements. This scalability of both the face sheets and the core allows the composite structure 10 to maintain its advantageous properties across a range of sizes, potentially enabling its use in applications ranging from small electronic components to large aerospace structures.

In some aspects, the method for producing the composite structure 10 may involve several steps. The process may begin with the preparation of the metal matrix composite (MMC) layers for both the upper face sheet 12 and the lower face sheet 14. This may involve selecting appropriate fibers and metal matrix materials based on the desired properties of the final structure.

The MMC layers may be produced using various techniques such as tape casting, powder metallurgy, or liquid metal infiltration. In some cases, the MMC may be produced in the form of tapes with specific widths and thicknesses. These tapes may then be cut to the desired dimensions for the face sheets.

Once the MMC tapes are prepared, they may be stacked to form the upper face sheet 12 and the lower face sheet 14. The stacking process may involve orienting the MMC layers at specific angles relative to one another. This orientation may be carefully controlled to achieve the desired mechanical properties in different directions.

In parallel with the preparation of the face sheets, the metallic core 16 may be fabricated. Depending on the specific design requirements, the metallic core 16 may be produced in various forms such as a honeycomb structure, a hollow extrusion, a corrugated structure, a truss structure, or a foam structure. The choice of core structure and material may depend on factors such as weight constraints, strength requirements, and thermal management needs.

Once the face sheets and core are prepared, the assembly process may begin. The metallic core 16 may be positioned between the upper face sheet 12 and the lower face sheet 14. The alignment of these components is important to ensure the structural integrity of the final composite.

The next step in the process may involve the ultrasonic welding of the components. This may begin with the welding of individual MMC layers within each face sheet. Each layer may be ultrasonically welded to adjacent layers, creating a cohesive, multi-layered structure for both the upper and lower face sheets.

Following the interlayer welding, the face sheets may be ultrasonically welded to the metallic core 16. This process may involve applying pressure to the materials while simultaneously introducing high-frequency vibrations. The combination of pressure and vibration may generate localized heat and friction at the interface, leading to the formation of a strong metallurgical bond between the face sheets and the core.

In some cases, the ultrasonic welding process may be performed in stages or sections, depending on the size and complexity of the composite structure 10. The welding parameters, such as frequency, amplitude, and duration, may be carefully controlled to ensure optimal bonding without damaging the MMC layers or the core structure.

After the welding process, the composite structure 10 may undergo a cooling period to allow the bonds to solidify fully. In some instances, post-processing steps such as heat treatment or surface finishing may be performed to enhance the properties or appearance of the final structure.

Throughout the manufacturing process, quality control measures may be implemented to ensure the integrity of the MMC layers, the accuracy of the layer orientations, and the strength of the ultrasonic bonds. These measures may include visual inspections, non-destructive testing techniques, and mechanical property evaluations.

The composite structure 10 may find utility in various applications across different industries due to its unique combination of properties. For instance, in the automotive industry, the composite structure 10 may be used for car chassis or suspension system components. The high strength-to-weight ratio and thermal stability of the composite structure 10 make it suitable for these applications, where weight reduction and high performance are important factors.

In some cases, the composite structure 10 may be used as end caps for cylindrical pressure vessels. The high strength and stiffness of the MMC layers in the upper face sheet 12 and the lower face sheet 14, combined with the structural benefits of the metallic core 16, can provide robust and lightweight solutions for pressure containment applications.

In high-temperature applications where traditional polymer composite sandwich structures cannot be used, the composite structure 10 may offer a viable alternative. The MMC layers in the upper face sheet 12 and the lower face sheet 14, comprising high-temperature resistant fibers and metal matrices, can withstand extreme temperatures without significant degradation of mechanical properties.

In some aspects, the composite structure 10 may be used for lightweight aluminum armor applications. The high tensile and compressive strength of the MMC layers in the upper face sheet 12 and the lower face sheet 14, along with the impact resistance provided by the metallic core 16, can offer superior protection with minimal weight penalties.

Furthermore, the composite structure 10 may find utility in applications where a sandwich structure needs to conduct heat. The metal matrices in the MMC layers of the upper face sheet 12 and the lower face sheet 14, along with the metallic core 16, can provide excellent thermal conductivity, facilitating efficient heat transfer across the structure. This can be particularly beneficial in applications such as electronic devices, where efficient heat dissipation is important for maintaining optimal performance and reliability.

In some cases, the composite structure 10 may be used in aerospace applications, such as aircraft fuselage panels or wing structures. The high strength-to-weight ratio, customizable properties, and potential for complex geometries make it suitable for these demanding applications where weight reduction and structural integrity are paramount.

The composite structure 10 may also find applications in the marine industry. Its corrosion resistance, particularly when using aluminum or titanium matrices, makes it suitable for boat hulls, decking, and other marine structures exposed to harsh saltwater environments.

In some aspects, the composite structure 10 may be utilized in the construction industry for architectural panels or load-bearing structures. The ability to tailor the properties of the composite structure 10 through fiber selection, matrix composition, and core design allows for optimization of strength, weight, and thermal insulation properties.

The composite structure 10 may also be suitable for use in renewable energy applications. For instance, it may be used in wind turbine blades, where its high strength-to-weight ratio and customizable properties can contribute to improved efficiency and durability.

In some cases, the composite structure 10 may find applications in the sports and recreation industry. Its lightweight nature combined with high strength and stiffness make it suitable for equipment such as bicycle frames, tennis rackets, or golf club shafts.

The composite structure 10 may also be used in the medical industry for applications such as prosthetics or orthopedic implants. The ability to tailor the mechanical properties and potentially incorporate biocompatible materials in the metal matrix can make it suitable for these specialized applications.

In some aspects, the composite structure 10 may be utilized in the aerospace industry for satellite structures or space vehicle components. Its high strength-to-weight ratio, thermal stability, and potential for radiation shielding (depending on the materials used) make it suitable for the extreme conditions of space environments.

The composite structure 10 may also find applications in the energy sector, such as in the construction of fuel cells or battery casings. The combination of lightweight properties, strength, and potential for electrical conductivity can be beneficial in these applications.

In some cases, the composite structure 10 may be used in the manufacturing of industrial machinery components. Its wear resistance, high strength, and potential for improved thermal management can make it suitable for applications such as cutting tools, dies, or high-speed moving parts.

Furthermore, the composite structure 10 may find utility in applications where a sandwich structure needs to conduct heat. The metal matrices in the MMC layers of the upper face sheet 12 and the lower face sheet 14, along with the metallic core 16, can provide excellent thermal conductivity, facilitating efficient heat transfer across the structure. This can be particularly beneficial in applications such as electronic devices, where efficient heat dissipation is important for maintaining optimal performance and reliability.

A number of implementations have been described. Nevertheless, it will be understood that various modifications may be made without departing from the spirit and scope of the disclosure. Accordingly, other implementations are within the scope of the following claims.

What is claimed is:

1. A composite structure comprising:
an upper face sheet comprising a plurality of metal matrix composite (MMC) layers;
a lower face sheet comprising a plurality of metal matrix composite (MMC) layers; and
a metallic core positioned between the upper face sheet and the lower face sheet,
wherein the MMC layers of the upper face sheet are oriented at angles ranging from about 0 degrees to about 90 degrees relative to one another and wherein the MMC layers of the lower face sheet are oriented at angles ranging from about 0 degrees to about 90 degrees relative to one another, and wherein the MMC layers of the upper face sheet and the lower face are joined to the metallic core through an ultrasonic bond.

2. The composite structure of claim 1, wherein the angles at which the MMC layers of the upper face sheet and the lower face sheet are oriented relative to one another may be between about 5 degrees and about 90 degrees.

3. The composite structure of claim 1, wherein each MMC layer comprises MMC tape having a width between about 0.5 inches and about 2 inches.

4. The composite structure of claim 1, wherein each MMC layer comprises MMC tape having a thickness between about 0.01 inches and about 0.03 inches.

5. The composite structure of claim 1, wherein the MMC layers comprise continuous fibers selected from the group consisting of carbon fibers, silicon carbide fibers, boron fibers, and aluminum oxide fibers.

6. The composite structure of claim 1, wherein the MMC layers comprise discontinuous fibers selected from the group consisting of whiskers, chopped fibers, and particulates.

7. The composite structure of claim 1, wherein the MMC layers comprise a metal matrix selected from the group consisting of aluminum, titanium, magnesium, and alloys thereof.

8. The composite structure of claim 1, wherein each of the upper face sheet and the lower face sheet comprises between 2 and about 10 MMC layers joined together by an ultrasonic bond.

9. The composite structure of claim 1, wherein the metallic core comprises a metal selected from the group consisting of aluminum, magnesium, titanium, and alloys thereof.

10. The composite structure of claim 1, wherein the metallic core may have a form selected from the group consisting of a honeycomb structure, a hollow extrusion, a corrugated structure, a truss structure, and a foam structure.

11. A composite structure comprising:
an upper face sheet comprising a plurality of metal matrix composite (MMC) layers, wherein the MMC layers comprise an aluminum matrix;
a lower face sheet comprising a plurality of metal matrix composite (MMC) layers, wherein the MMC layers comprise an aluminum matrix; and
an aluminum core positioned between the upper face sheet and the lower face sheet,
wherein the MMC layers of the upper face sheet and the lower face sheet are oriented at angles relative to one another, and wherein the MMC layers of the upper face sheet and the lower face are joined to the aluminum core through an ultrasonic bond.

12. The composite structure of claim 11, wherein the upper face sheet comprises between 2 and about 10 MMC layers, and the lower face sheet comprises between 2 and about 10 MMC layers joined together by an ultrasonic bond.

13. The composite structure of claim 11, wherein each MMC layer comprises MMC tape having a width between about 0.5 inches and about 2 inches.

14. The composite structure of claim 11, wherein each MMC layer comprises MMC tape having a thickness between about 0.01 inches and about 0.03 inches.

15. The composite structure of claim 11, wherein the aluminum core may have a form selected from the group consisting of a honeycomb structure, a hollow extrusion, a corrugated structure, a truss structure, and a foam structure.

16. A method for making a composite structure, the method comprising:
providing a plurality of metal matrix composite (MMC) layers for an upper face sheet;
providing a plurality of metal matrix composite (MMC) layers for a lower face sheet;
orienting the MMC layers of the upper face sheet and the lower face sheet at angles relative to one another;
providing a metallic core;
positioning the metallic core between the upper face sheet and the lower face sheet; and
ultrasonically bonding the upper face sheet, the lower face sheet, and the metallic core together to form the composite structure.

17. The method of claim 16, wherein the MMC layers of the upper face sheet and the lower face sheet comprise a metal matrix selected from the group consisting of aluminum, titanium, magnesium, and alloys thereof.

18. The method of claim 16, wherein each MMC layer comprises MMC tape having a width between about 0.5 inches and about 2 inches and a thickness between about 0.01 inches and about 0.03 inches.

19. The method of claim 16, wherein the metallic core may have a form selected from the group consisting of a honeycomb structure, a hollow extrusion, a corrugated structure, a truss structure, and a foam structure.

20. The method of claim 16, wherein providing the plurality of MMC layers for the upper face sheet and providing the plurality of MMC layers for the lower face sheet comprises providing between 2 and about 10 MMC layers for each of the upper face sheet and the lower face sheet.

21. The method of claim 16, further comprising ultrasonically welding the MMC layers of the upper face sheet together and ultrasonically welding the MMC layers of the lower face sheet together prior to positioning the metallic core between the upper face sheet and the lower face sheet.
